(19) United States
(12) Patent Application Publication
(10) Pub. No.: US 2016/0026248 A1
(43) Pub. Date: Jan. 28, 2016

(54) Haptic Communication System, Method and Device

(71) Applicant: HOLLAND HAPTICS B.V., Delft (NL)

(72) Inventor: Frederic Francois Petrignani, Amsterdam (NL)

(21) Appl. No.: 14/774,983

(22) PCT Filed: Mar. 6, 2014
(86) PCT No.: PCT/NL2014/050133

§ 371 Date: Sep. 11, 2015

(30) Foreign Application Priority Data
Mar. 14, 2013 (NL) 1040096

(51) Int. Cl. G06F 3/01; G06F 3/041

(52) U.S. Cl. CPC G06F 3/016; G06F 3/011; G06F 3/0414

(57) ABSTRACT

A haptic communication system, comprising two haptic input/output devices connected to a computer network, said haptic input/output devices each comprising: at least one actuator in a housing, wherein said actuator comprises a motor, a carrier being moved in said at least two opposite directions by said motor, and a touch member having an outer surface, said touch member being arranged to be moved at predetermined intervals in at least two opposite directions relative to said housing, such that a user can feel said movement by touching said outer surface; wherein computer software is arranged to use relative pressure, relative location and the difference between the current relative location and at least the relative location determined in the previous interval, of two corresponding actuators in said two devices to calculate two next relative locations of outer surfaces, one for each of said actuators, and to communicate said next relative positions to the respective actuators; and wherein said actuators are arranged to move said outer surfaces instantly to the calculated and communicated next relative location.

The invention relates to a haptic communication system. A haptic communication system is a system that can communicate the sense of touch through interactive surfaces, comprising two devices in communication with each other. Manipulation of the surfaces is achieved by at least one actuator in each device moving said surfaces, and two users, one on each device, putting pressure on said surfaces.

The invention aims at a cost effective and/or reliable system which give users a haptic sensing experience which is as natural as possible.

According to the invention, the system comprises a computer network comprising at least one computer having a processing unit, and two haptic input/output devices connected to said computer network at different locations, and computer software arranged to run on said computer processing unit, said haptic input/output devices each comprising: a housing arranged to be placed in a stable manner on a flat surface; at least one actuator in said housing, wherein said actuator comprises a motor, a carrier being moved in said at least two opposite directions by said motor, and a touch member having an outer surface, said touch member being arranged to be moved at predetermined intervals in at least two opposite directions relative to said housing, such that a user can feel said movement by touching said outer surface; said actuator being provided with means arranged to determine continuously at said predetermined intervals the relative pressure on said outer surface and with means to determine continuously the relative location of said outer surface, and means arranged to communicate continuously at said predetermined intervals said relative pressure and said relative location to said computer processing unit; wherein said computer software is arranged to use said relative pressure, said relative location and the difference between the current relative location and at least the relative location determined in the previous interval, of two corresponding actuators in said two devices to calculate two next relative locations of outer surfaces, one for each of said actuators, and to communicate said next relative positions to the respective actuators; and wherein said actuators are arranged to move said outer surfaces instantly to the calculated and communicated next relative location.

Said actuator preferably comprises a resilient element, such as a spring, between said carrier and said touch member, such that the distance between said carrier and said outer surface can be made shorter by exerting a force on said outer surface.

Preferably said carrier is mounted in a bearing which allows reciprocating linear movement. The motor of said actuator is preferably a rotational stepping motor, wherein the shaft of said motor is connected to said reciprocating carrier by means of a rotating arm.

Preferably said haptic input/output devices are substantially identical and each device comprises a multitude of said actuators, wherein said software is arranged to communicate said pressure and location parameters between each one actuator in one device and the corresponding actuator in the other device.

In a preferred embodiment said haptic input/output devices have dimensions so as to fully support an average adult person's hand, wherein said multitude of actuators are arranged such that the outer surfaces of said actuators extend in a substantially flat surface and can simultaneously support all different parts of said hand, being at least each of the five fingers and the palm of said hand, and wherein said carriers are arranged to reciprocate perpendicular to said substantially flat surface. Preferably said different parts of said hand are at least two locations along the length of each of the five fingers and at least two locations along the length of the palm of said hand.

Said outer surfaces of said multitude of actuators are preferably covered by one flexible membrane, for instance a rubber membrane.

Said computer software is preferably arranged to calculate said two next relative locations of said outer surfaces such, that if no pressure is determined in one of said actuators, and a pressure is determined in the corresponding actuator, said two actuators are moved to two opposite extreme positions in accordance with the determined pressures, and wherein if in both actuators an more or less equal pressure is determined the two actuators are both moved to central positions, at a velocity which takes into account said differences between current relative locations and relative locations determined in the previous intervals as well as pressures determined in previous intervals, such that a smooth natural feeling movement and pressure is experienced by users operating the devices as if their two hands were in mutual physical contact.

In the preferred embodiment said software is arranged to calculate said two next relative locations with a “time domain passivity control” algorithm. Such “time domain passivity control” algorithms for haptic interfaces are described and explained in detail in the US patent application publication 2002/0062177 A1, which is incorporated herein by reference. This document teaches the skilled person how the software should calculate the positions of the actuators with input parameters as mentioned above, in order to achieve required behaviour of the actuators. In the method of the invention the velocity parameter as described in said publication is represented by the differences between current relative locations and relative locations determined in the previous intervals, as the velocity of the carriers can be expressed by the incremental differences in their location divided by the duration of the interval. The software programme does not need to be arranged to actually calculate velocities therefore. However, if the software programme would actually calculate velocities and use these velocities to calculate the two next relative locations, this should be considered to be an equivalent feature to the feature that the difference between the current relative location and at least the relative location determined in the previous interval is used as an input parameter.

Optionally, in order to even further improve the natural feel of the haptic communication system, it may be possible to arrange the computer programme such that determined pressures, relative locations, and differences between the current relative location and at least the relative location determined in the previous interval, of neighbouring actuators of the two respective actuators are also used by said computer software programme to calculate the next relative positions of the two respective actuators.

The predetermined interval of the system is preferably less than 50 ms, more preferably less than 15 ms, still more preferably less than 5 ms. The smaller the interval, the smoother the system will react. The possible interval is largely dependent on the processing power of the processing unit(s) used.

The invention furthermore relates to a haptic input/output device comprising: a housing arranged to be placed in a stable manner on a flat surface; at least one actuator in said housing, wherein said actuator comprises a motor, a carrier being moved in said at least two opposite directions by said motor, and a touch member having an outer surface, said touch member being arranged to be moved at predetermined intervals in at least two opposite directions relative to said housing, such that a user can feel said movement by touching said outer surface; said actuator being provided with means arranged to determine continuously at said predetermined intervals the relative pressure on said outer surface and with means to determine continuously the relative location of said outer surface, and means arranged to communicate continuously at said predetermined intervals said relative pressure and said relative location to a computer processing unit; and wherein said actuator is arranged to move said outer surface instantly to a calculated and communicated next relative location.

Furthermore the invention relates to a method for communicating haptic sense between two persons, using a haptic communication system comprising a computer network comprising at least one computer having a processing unit, and two haptic input/output devices connected to said computer network at different locations, and computer software running on said computer processing unit, said haptic input/output devices each comprising: a housing placed in a stable manner on a flat surface; at least one actuator in said housing, wherein said actuator comprises a motor, a carrier being moved in said at least two opposite directions by said motor, and a touch member having an outer surface, said touch member moving at predetermined intervals in at least two opposite directions relative to said housing, such that a user feels said movement by touching said outer surface and can exert pressure on said touch surface in order to move said touch member; said actuator being provided with means which determine continuously at said predetermined intervals the relative pressure on said outer surface and with means which determine continuously the relative location of said outer surface, and means which communicate continuously at said predetermined intervals said relative pressure and said relative location to said computer processing unit; wherein said computer software uses said relative pressure, said relative location and the difference between the current relative location and at least the relative location determined in the previous interval, of two corresponding actuators in said two devices to calculate two next relative locations of outer surfaces, one for each of said actuators, and communicates said next relative positions to the respective actuators; and wherein said actuators move said outer surfaces instantly to the calculated and communicated next relative location.

The invention also relates to a computer software programme arranged to carry out the method, as well as to a haptic input/output device in combination with such a computer software programme.

The invention will now be described by means of a preferred embodiment, with reference to the drawings, wherein:

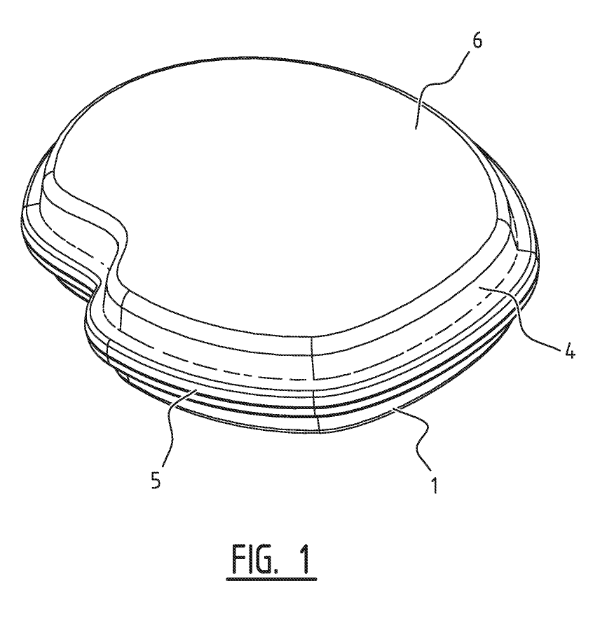

FIG. 1 is a perspective view of a haptic device used in the system of the invention;

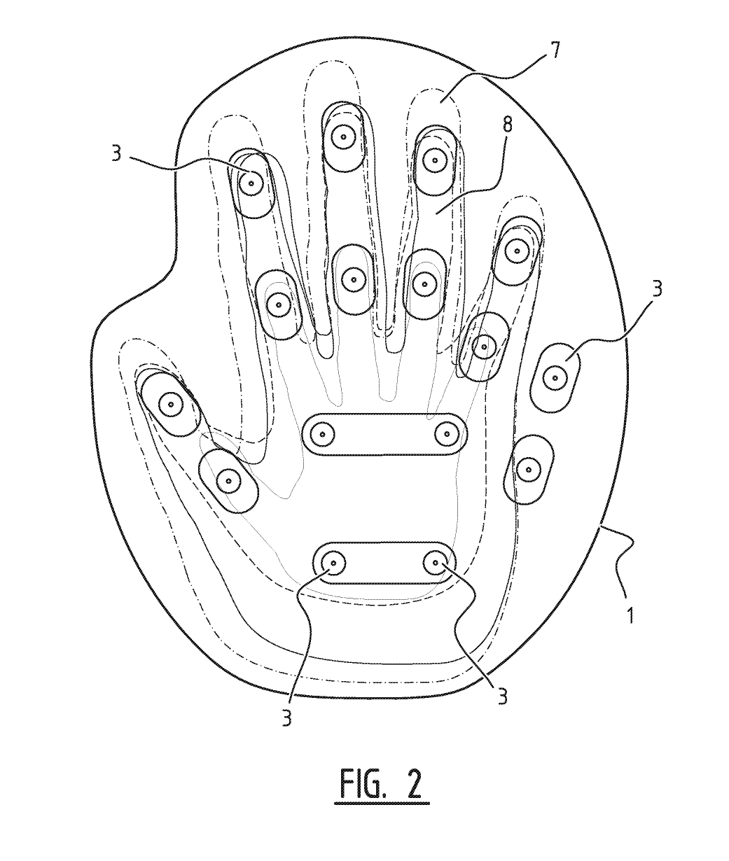

FIG. 2 is a schematic layout, seen from above, of actuators in the haptic device of FIG. 1;

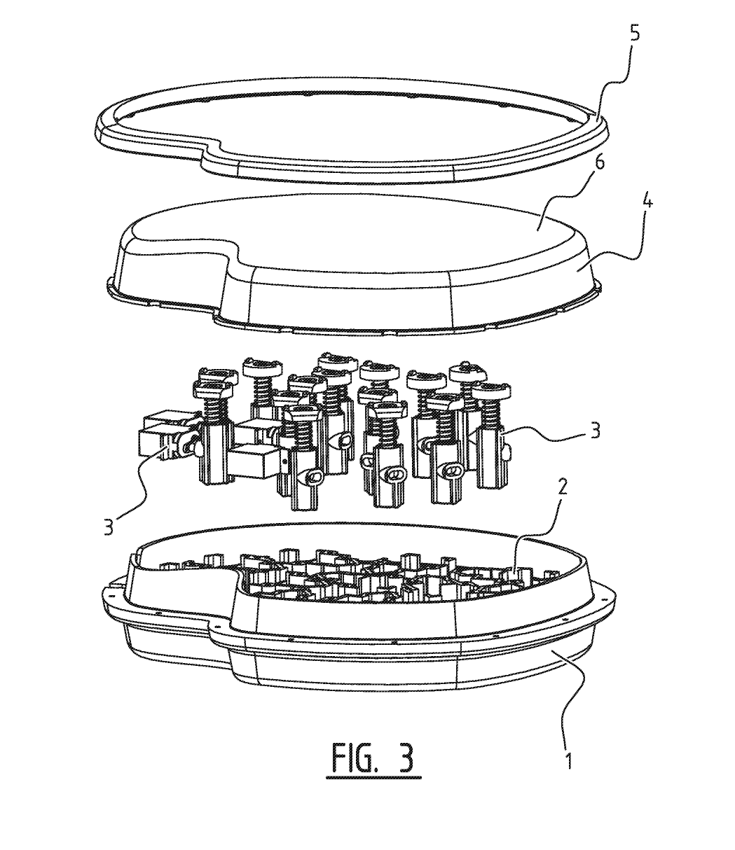

FIG. 3 is a perspective explosion view of the device of FIG. 1;

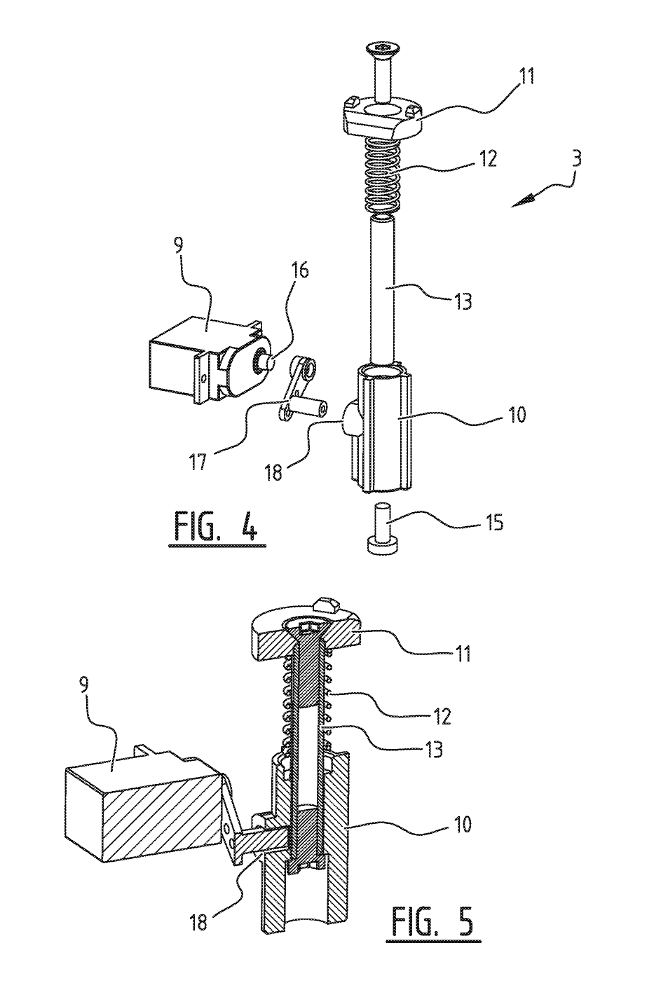

FIG. 4 is a perspective explosion view of an actuator used in the haptic device of FIG. 1;

FIG. 5 is a perspective sectional view of the actuator of FIG. 4;

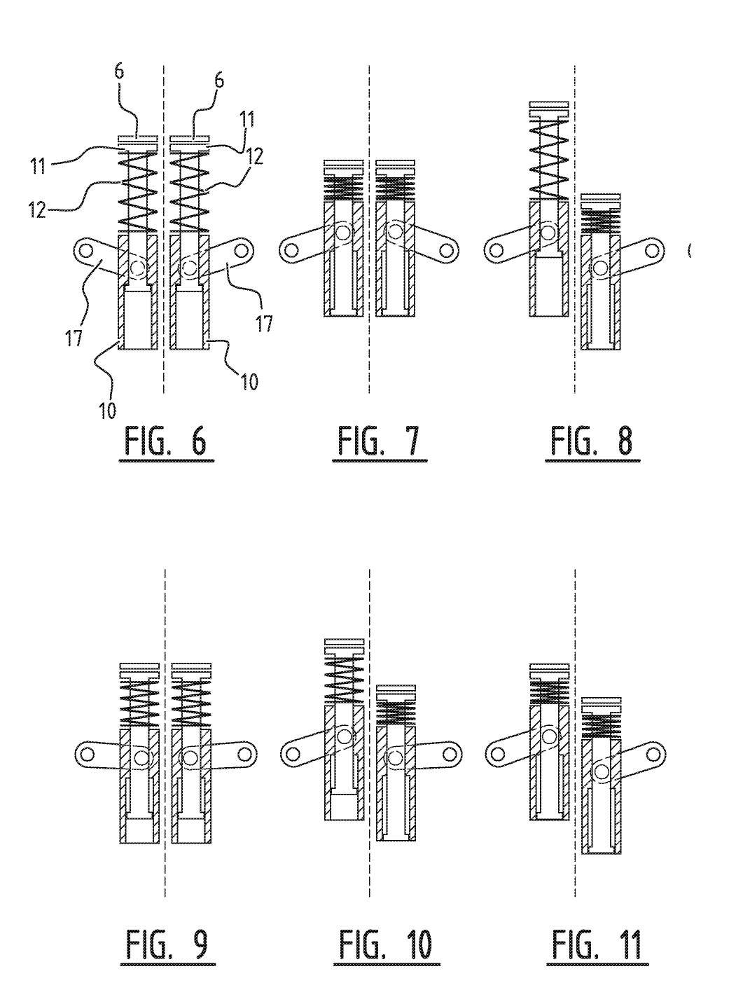

FIGS. 6-11 are sectional views of pairs of respective actuators in two haptic devices of FIG. 1 in various operational conditions when operating in a system according to the invention; and

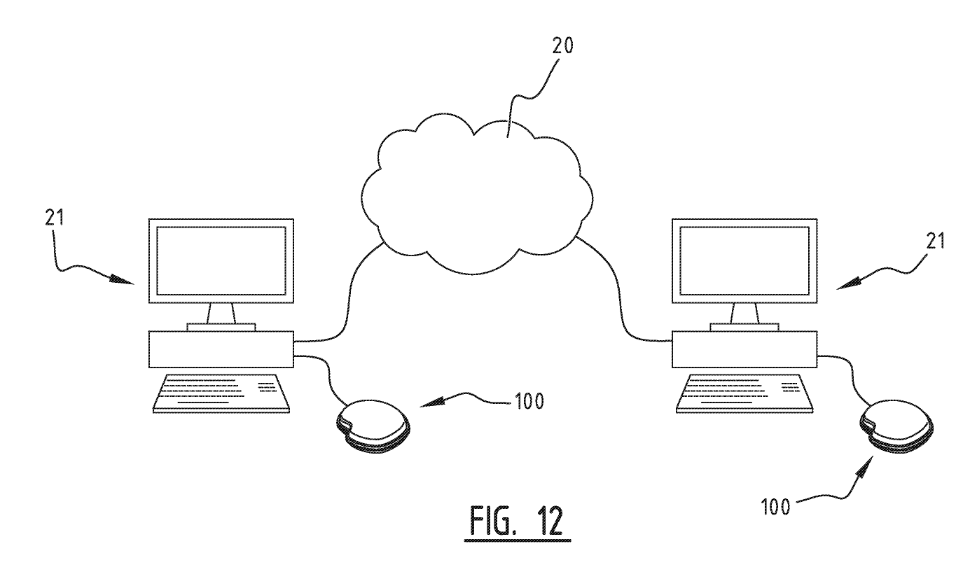

FIG. 12 is a schematic view of a system according to the invention.

According to FIGS. 1 and 3 the haptic device comprises a housing comprising a plastic bottom shell 1, which can be placed stably on a table. The shell 1 is provided with retainers 2 for the plurality of actuators 3. The housing further comprises a lid 4 which is placed on top of the bottom shell 1, and fastened thereto by sealing ring 5. The top surface 6 of the lid 4 is made of a flexible rubber sheet which rests on the top surfaces of the actuators 3.

The shape and dimensions of the lid 4 are designed to easily accommodate the hand of most adult persons thereon. As shown in FIG. 2, the actuators 3 are placed in the bottom shell 1 in such a manner that for an average adult person's hand 7, the outer ends of each one of the five fingers are supported by one respective actuator 3, the central parts of each one of the five fingers are supported by one respective actuator 3, the palm portion adjacent the wrist is supported by two respective (interconnected) actuators 3, and the palm portion adjacent the fingers is supported by two respective (interconnected) actuators 3. For a child's hand 8, at least one actuator 3 will support each finger. Two extra actuators 3 are placed on the right side of the shell 1, to be able to support the thumb of a left hand, such that the device is suited for both left and right handed people.

As shown in FIGS. 4 and 5, each actuator 3 comprises a stepping motor 9, a carrier 10 and a touch member 11. The carrier 10 can move up and down in their respective retainers 2. The touch member 11 is mounted on a shaft 13 by means of screw 14, which shaft 13 can move up and down inside a through hole in the carrier 10. Said movement is limited in upward direction by the head of screw 15. A helical spring 12 is placed between the top surface of the carrier 10 and the bottom surface of the touch member 11. The motor 9 has an outgoing driven shaft 16, on which an arm 17 is mounted, such that the arm 17 can be moved up and down in small steps. The outer end of the arm 17 is slidably mounted in a slot 18 in the side wall of the carrier 10. Inside the motor a pressure sensor is present, which can determine the force that is exerted by the shaft 16, and the rotational position of the shaft 16 is also determined, and both determined values can be communicated to a personal computer 21, such as the ones shown in FIG. 12.

FIGS. 6-11 shows the working principle of the haptic communication system by different examples of relative positions and pressure states of the springs 12 of the pairs of actuators 3 of the two haptic devices.

In FIG. 6 in both the left and right actuators no pressure is sensed. The carrier of both the left and right actuators are kept in position (or may be moved to the lowest position as starting position for use). The springs of both actuators are uncompressed.

In FIG. 7 in both the left and right actuators maximum pressure is sensed. The carrier of both the left and right actuators are sent to the highest position. The springs of both actuators show maximum compression.

In FIG. 8 in the left actuator no pressure is sensed, and in the right sensor maximum pressure is sensed. The carrier of the left actuator is sent to the highest position and the carrier of the right actuator is sent to the lowest position. The spring of the left actuator is uncompressed, the spring of the right actuator shows maximum compression.

In FIG. 9 in both the left and right actuators an equal medium pressure is sensed. The carrier of both the left and right actuators are kept in the same position. The springs of both actuators show medium compression.

In FIG. 10 in the left actuator medium pressure is sensed, and in the right sensor maximum pressure is sensed. The carrier of the left actuator is sent to a high (but not the highest) position and the carrier of the right actuator is sent to a low (but not the lowest) position. The spring of the left actuator shows medium compression, the spring of the right actuator shows maximum compression.

In FIG. 11 in the left actuator maximum allowable pressure is sensed, and in the right sensor more than the maximum allowable sensor is sensed. The carrier of the left actuator is slowly sent to the lowest position, and the carrier on the right is slowly sent to the highest position. Both springs show maximum compression.

According to the invention, the response of the actuators (in terms of positions of the carrier 10 and the velocity of the changes in said positions) not only depends on the instant positions and pressures sensed in the actuators, but also on the velocity of the changes in positions (by using differences with previously determined positions), whereby a very natural feeling haptic response can be achieved, in which the impact of a movement can be accounted for. Instructions for achieving desired such responses are provided in the US patent application publication US 2002/0062177 A1 which is incorporated herein by reference.

FIG. 12 shows the system of the invention, wherein two personal computers 21 are connected through the internet 20, and each personal computer is connected to a haptic device 100 as described hereinbefore.

The invention has thus been described by means of a preferred embodiment. It is to be understood, however, that this disclosure is merely illustrative. Various details of the structure and function were presented, but changes made therein, to the full extent extended by the general meaning of the terms in which the appended claims are expressed, are understood to be within the principle of the present invention. The description and drawings shall be used to interpret the claims. The claims should not be interpreted as meaning that the extent of the protection sought is to be understood as that defined by the strict, literal meaning of the wording used in the claims, the description and drawings being employed only for the purpose of resolving an ambiguity found in the claims. For the purpose of determining the extent of protection sought by the claims, due account shall be taken of any element which is equivalent to an element specified therein.

1. A haptic communication system, comprising:
a computer network comprising at least one computer having a processing unit;
two haptic input/output devices connected to said computer network at different locations; and
computer software arranged to run on said computer processing unit,
wherein the said haptic input/output devices each comprise:
a housing arranged to be placed in a stable manner on a flat surface;
at least one actuator in said housing, wherein said actuator comprises a motor, a carrier being moved in said at least two opposite directions by said motor, and a touch member having an outer surface, said
a touch member being arranged to be moved at predetermined intervals in at least two opposite directions relative to said housing, such that a user can feel said movement by touching said outer surface,
wherein said actuator being provided with means arranged to determine continuously at said predetermined intervals the relative pressure on said outer surface and with means to determine continuously the relative location of said outer surface, and means arranged to communicate continuously at said predetermined intervals said relative pressure and said relative location to said computer processing unit,
wherein said computer software is arranged to use said relative pressure, said relative location and the difference between the current relative location and at least the relative location determined in the previous interval, of two corresponding actuators in said two devices to calculate two next relative locations of outer surfaces, one for each of said actuators, and to communicate said next relative positions to the respective actuators, and
wherein said actuators are arranged to move said outer surfaces instantly to the calculated and communicated next relative location.

2. A haptic communication system in accordance with claim 1, wherein said actuator comprises a resilient element between said carrier and said touch member, such that the distance between said carrier and said outer surface can be made shorter by exerting a force on said outer surface.

3. A haptic communication system in accordance with claim 1, wherein said carrier is mounted in a bearing which allows reciprocating linear movement.

4. A haptic communication system in accordance with claim 3, wherein the motor of said actuator is a rotational stepping motor, wherein the shaft of said motor is connected to said reciprocating carrier by means of a rotating arm.

5. A haptic communication system in accordance with claim 1, wherein said haptic input/output devices are substantially identical and each device comprises a multitude of said actuators, wherein said software is arranged to communicate said pressure and location parameters between each one actuator in one device and the corresponding actuator in the other device.

6. A haptic communication system in accordance with claim 5, wherein said haptic input/output devices have dimensions so as to fully support an average adult person's hand, wherein said multitude of actuators are arranged such that the outer surfaces of said actuators extend in a substantially flat surface and can simultaneously support all different parts of said hand, being at least each of the five fingers and the palm of said hand, and wherein said carriers are arranged to reciprocate perpendicular to said substantially flat surface.

7. A haptic communication system in accordance with claim 6, wherein said different parts of said hand are at least two locations along the length of each of the five fingers and at least two locations along the length of the palm of said hand.

8. A haptic communication system in accordance with claim 1, wherein said outer surfaces of said multitude of actuators are covered by one flexible membrane.

9. A haptic communication system in accordance with claim 1, wherein said computer software is arranged to calculate said two next relative locations of said outer surfaces such, that if no pressure is determined in one of said actuators, and a pressure is determined in the corresponding actuator, said two actuators are moved to two opposite extreme positions in accordance with the determined pressures, and wherein if in both actuators a more or less equal pressure is determined the two actuators are both moved to central positions, at a velocity which takes into account said differences between current relative locations and relative locations determined in the previous intervals as well as pressures determined in previous intervals, such that a smooth natural feeling movement and pressure is experienced by users operating the devices as if their two hands were in mutual physical contact.

10. A haptic communication system in accordance with claim 1, wherein said software is arranged to calculate said two next relative locations with a “time domain passivity control” algorithm.

11. A haptic communication system in accordance with claim 1, wherein said predetermined interval is less than 50 ms, preferably less than 15 ms, more preferably less than 5 ms.

12. A haptic input/output device comprising:
a housing arranged to be placed in a stable manner on a flat surface;
at least one actuator in said housing, wherein said actuator comprises a motor, a carrier being moved in said at least two opposite directions by said motor, and a touch member having an outer surface, said touch member being arranged to be moved at predetermined intervals in at least two opposite directions relative to said housing, such that a user can feel said movement by touching said outer surface,
wherein said actuator being provided with means arranged to determine continuously at said predetermined intervals the relative pressure on said outer surface and with means to determine continuously the relative location of said outer surface, and means arranged to communicate continuously at said predetermined intervals said relative pressure and said relative location to a computer processing unit,
and wherein said actuator is arranged to move said outer surface instantly to a calculated and communicated next relative location.

13. A method for communicating haptic sense between two persons, using a haptic communication system comprising:
connecting two haptic input/output devices to a computer network at different locations;
placing a housing of each of the two haptic input/output devices in a stable manner on a flat surface;
moving a carrier disposed within an actuator in the housing of each of the two haptic input/output devices in at least two opposite directions by a motor; and a touch member having an outer surface,
moving a touch member disposed in each actuator at predetermined intervals in at least two opposite directions relative to said housing, such that a user feels said movement by touching an outer surface of the touch member and can exert pressure on said touch surface in order to move said touch member;
continuously determining during the predetermined intervals the relative pressure on said outer surface
continuously determining a relative location of said outer surface of the touch member;
continuously communicating during the predetermined intervals the determined relative pressure and the determined relative location to the computer network;
calculating a next relative location for each outer surface of each touch member using the determined relative pressure, the determined relative location and a difference between the current relative location and a relative location determined in the previous interval of the two corresponding actuators within the two haptic input/output devices;
communicating the next determined relative location for each outer surface of each touch member to the respective actuators; and
moving the outer surfaces of each touch member instantly to the calculated and communicated next relative location.

14. A computer software programme arranged to carry out the method of claim 13.

15. A haptic input/output device as defined in claim 1 in combination with a computer software programme arranged to carry out the method of claim 13.
